(19) United States
(12) Patent Application Publication
(10) Pub. No.: US 2002/0162272 A1
(43) Pub. Date: Nov. 7, 2002

(54) Fishing bait organizer and storage case

(76) Inventor: Jason C. Pripusich, Lisle, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 09/848,567

(22) Filed: May 3, 2001

(51) Int. Cl. A01K 97/00; A01K 97/04

(52) U.S. Cl. 43/54.1

(57) ABSTRACT

The present invention is directed to a bait organizer and storage case for fishing. In a preferred embodiment the case is for organizing and categorizing soft plastic bait bags, and the case is made out of a soft durable nylon-type material and a soft interior nylon.

### BACKGROUND OF THE INVENTION

The present invention is directed towards a bait organizer and storage case for fishing. In a preferred embodiment, the case is for organizing and categorizing soft plastic bait bags, and the case is made out of a soft durable nylon-type material and a soft interior nylon.

For many years, conventional tackle boxes made of hard plastic were the standard and are still produced today. Most typical design types involve a bottom and hinged top with moveable storage trays inside. These trays allow general storage of various small sized fishing tackle and equipment. The bases of these tackle boxes also provide some bulk storage options for a limited amount of larger items as well. These tackle boxes also exist in forms where several plastic utility boxes of various sizes can be removed a drawer or cartridge format. These utility boxes are usually compartmentalized with dividers, and allow for storing miscellaneous smaller baits or tackle items.

The introduction of soft-sided tackle cases allowed for greater bulk storage of various “utility” boxes and other fishing tackle items. While both of these hard and soft tackle box designs generally address some of the storage, organization and accessibility of smaller tackle items, such as hooks, weights, small baits, and tools, designs simply to do not allow for the proper storage and organization of soft plastic bait packages. Plastic bait bags are too bulky and large to be stored effectively. Given the wide variety of plastic bait colors and styles these versions of tackle boxes simply do not function to satisfy this storage need. Their intended purpose is not for the specific storing of soft plastic bait packages.

As a result of this, along with the ever-increasing popularity of soft plastic baits, manufacturers began producing cases which attempted to specifically address the storage and organization of these baits. The most common form available today is the worm wrap or worm binder. This typically consists of a zippered case with plastic zip-sealing type bags inside. Some versions allow for the binding of manufactured bait packages directly to interior elements within the case. But most involve removing plastic baits from their original manufactured bags or inserting these packages directly into zip-seal bag enclosures. These worm binders allow for a turn the page or album style search to locate a desired bait. This design permits a minimal amount of baits that may be stored in any given single worm binder, usually 10-15 bait bags.

The design of these worm wraps or binders is deficient in the following ways.

First, they have limited capacity. Avid fishermen to tournament anglers tend to own and fish with a very large array of soft plastic baits. It is very common for fishermen to have 50 to 250 of these bait packages with them during a fishing outing. An angler would need 5 to 15 of these worm wraps or binders to accommodate all these baits.

Second, they are impractical for organizing and categorizing large numbers of soft plastic bait packages. As a result an angler would have to search and fumble through multiple worm wraps to locate the desired case containing the desired bait.

Third, they do not allow for quick accessibility of a desired bait. Often anglers need to access baits quickly for a specific situation, condition or area they are fishing. To access a desired bait from a worm wrap or binder requires multiple tasks. Upon locating the correct binder, you must unzip the case and page through multiple packages until you identify the desired bait. Then open the plastic zip-sealing bag to access the factory bait package, remove the factory bait package, and then finally open the factory bait package to gain access to the desired individual worm or bait.

Fourth, they do not allow for easy and quick bait identification. The worm wrap or binder designs fail to allow an angler to view a large selection of stored baits at a glance.

Fifth, they may require the transfer of the soft baits from the manufactured package into plain zip sealing bags common to the worm wrap or binder. Soft plastic baits are typically scented with flavor enhancers inside their manufactured zip-sealed bags. This desired feature adds greatly to the baits ability to entice fish. When scented baits are removed from their factory packages and transferred to sterile bags, they lose their scent and color as well. The effectiveness of the bait is diminished. As a result the vast majority of fishermen would prefer to keep their plastic baits in their original manufactured bags.

Sixth, they fall short in terms of overall convenience for at least all the reasons described above and with respect to portability, a fisherman would need to use a separate carrying case to store and tote the multiple worm wraps or binders he would have.

The present invention is directed to a case which overcomes these deficiencies in the prior products.

### SUMMARY OF THE INVENTION

The present invention is directed to a fishing case wherein the case is divided so the bait and other fishing items can be easily stored and located.

In one embodiment, the present invention is directed to a bait organizer and carrying case having a middle divider and labeled cards for organizing bait and other similar fishing items. The labeled cards act as a file system for complete categorization of specific bait types. Preferably, the case can be used for categorization of soft plastic bait bags.

In a further embodiment, the case is made out of a soft material such as, for example, water resistant durable nylon.

In a further embodiment, the case has a heavy duty zipper, an adjustable and preferably removable carrying strap, a durable center divider, a large, preferably zippered, pouch inside the cover of the case and a water proof bottom. Preferably, the cards are durable plastic index cards with labels.

In an embodiment of the present invention, ten such index cards are used, allowing the categorization of a minimum of 60 standard size bait bags within the case.

In another embodiment of the present invention, the case is made of a sturdy molded plastic. For example, the case can be made out of a clear molded plastic with three hinges, two closing tabs, molded durable center divider and a plastic lid. This case also can have a file system for complete categorization of specific bait types using plastic index cards with labels. For example, ten such index cards can be used to catagorize a minimum of 50 standard size bait bags.

### BRIEF DESCRIPTION OF DRAWINGS

FIG. 1 is schematic showing a case according to the present invention with an optional carrying strap;

FIG. 2 illustrates a card used for organizing and categorizing bait and other similar fishing items within the case of the present invention;

FIG. 3 shows example labels for customizing the cards of FIG. 2; and

FIG. 4 is a schematic of another embodiment of the present invention wherein the case is made of a molded plastic.

### DETAILED DESCRIPTION OF PRESENTLY PREFERRED EMBODIMENTS

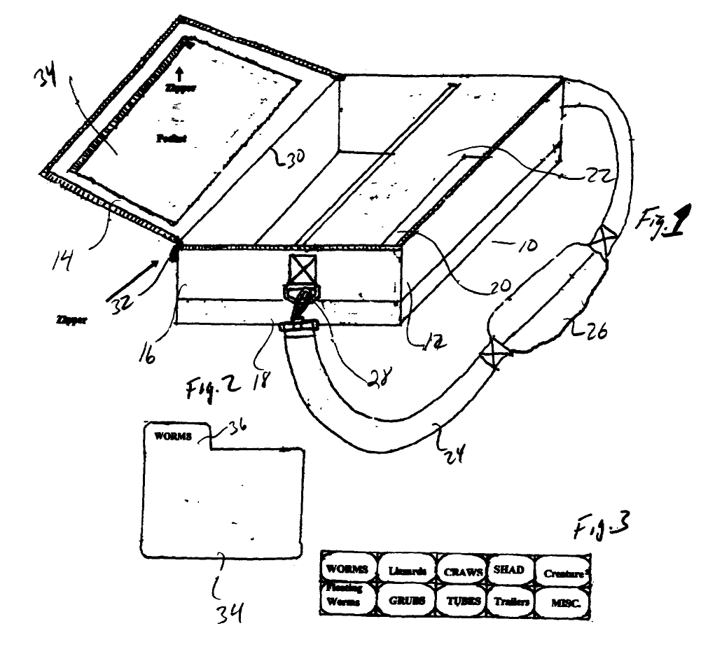

FIG. 1 is directed to a first preferred embodiment of the present invention and illustrates a soft plastic bait bag organizer and carrying case 10.

In this preferred embodiment, the carrying case 10 is made of nylon. In alternative embodiments, the present invention can be made of similar type soft materials or plastic. Case 10 has a bottom section 12 and a top lid 14. Preferably, bottom section 12 is comprised of two sections, a soft-sided, water resistance portion 16 made of a durable nylon and a water proof bottom 18. Preferably, waterproof bottom 18 is attached to water resistance portion 16 by heavy duty stitching or a water proof adhesive with, for example, silicone. However, the present invention is not limited to the means for attachment for these two sections. Alternatively, bottom section 12 can be one section and made with only one material. In one example embodiment, the water proof bottom 18 can be approximately 1½″ in height and 15×15″ in width and length while soft portion 16 is located directly above bottom 18 and has a height of approximately 3″ and the same length and width. The present invention, however, is not limited to these sizes as they are provided for illustrative purposes only.

Case 10 also includes within bottom section 12 an interior portion 20 preferably having a nylon lining. Interior portion 20 includes a divider wall 22 which is preferably made of a durable material and stretches from one end to the other end of interior portion 20. As an example, divider wall 22 can be molded into the bottom of portion 20. Preferably, divider wall 22 stretches lengthwise and has a ¼ inch thickness and is 3 inches height. Alternatively, it could stretch width-wise and be other sizes. Additional dividers are also contemplated in the present invention.

In one option for the case of the present invention, attached to the bottom portion 12, and preferably along the soft sided portion 16, is a strap 24 for ease in carrying the case. In the preferred embodiment, strap 24 has a pad 26 for comfort and is attached to the case with a D-ring 28 on each end of the case. It is preferred that this strap have reinforced stitching and be adjustable and removable.

Case 10 includes top lid 14. Top lid 14 preferably is permanently affixed to bottom portion 14 along one wall 30 and removably affixed to the other portions of the bottom using a zipper 32 or other types of fastening devices such as velcro. Preferably, the zipper is a heavy duty zipper. The top portion can also include a pocket 34, either inside or outside the lid or both, for further storage. This pocket can be made of a mesh material or a light clear plastic and can either have a zipper to open and close or be in the form of a pouch.

Preferably, the case also includes identification cards to divide and organize and catagorize the bait or other fishing items. FIG. 2 illustrates an example of such a card.

In a preferred embodiment, the card 36 is made of a white plastic and is ¼″ thick and has rounded corners. On the main portion of the card, detailed information or notes on the bait or other items can be placed. Alternatively, this portion of the card can be blank. The card also preferably has measurements on the bottom of 6½″ in length while one side is 3½″ long and the other side is 4½″ long with a top raised portion 2″ tall. The present invention, however, is not limited to such sizes or type of index cards as other sizes are contemplated within the scope of the invention. In one embodiment of the present invention, ten such index cards are used, allowing the categorization of a minimum of 60 standard size bait bags within the case.

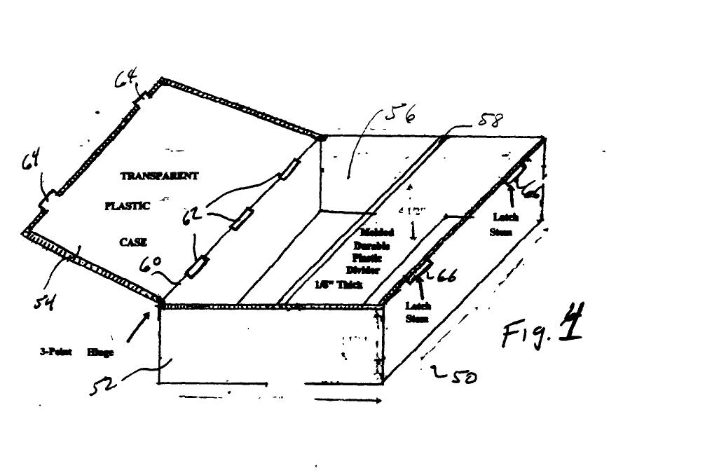

In a further preferred embodiment, adhesive white labels such as those shown in FIG. 3 can be applied to the upper portion of the card at position 36 in order to customize and identify what is located at that portion of the bait organizer and carrying case.

In another embodiment shown in FIG. 4, the entire carrying case 50 is made of plastic. Case 50 has a bottom section 52 and a top lid 54. In one example embodiment, the bottom 52 can be approximately 4½″ in height and 15×15″ in width and length. The present invention, however, is not limited to these sizes as they are provided for illustrative purposes only. Case 50 also includes within bottom section 52 an interior portion 56. Interior portion 56 includes a divider wall 58 which preferably molded to the bottom and side and stretches from one end to the other end of interior portion 56. Preferably, it stretches lengthwise and has a ¼ inch thickness and is 3 inches height and is made of a durable plastic. Alternatively, it could stretch width wise and be other sizes. Additional dividers are also contemplated in the present invention.

In one option to the case of the present invention, a strap (not shown), similar to that discussed for the first embodiment, can be attached to the case for ease in carrying the case.

Case 50 includes top lid 54. Top lid 54 preferably is affixed to bottom portion 54 along one wall 60 by two or three hinges 62 and has one or two closing tabs 64 to secure the lid. Preferably, such tabs 64 are used in conjunction with latch stems 66 located on bottom portion 52.

Preferably the case also includes index cards and labels in which to divide and organize the soft plastic bag bait or other fishing items, such as those described for the first embodiment. For example, ten such index cards can be used to catagorize a minimum of 50 standard size bait bags.

This description has been offered for illustrative purposes only and is not intended to limit the invention of this application, which is defined in the claims below.

What is claimed as new and desired to be protected by Letters Patent is set forth in the appended claims.

I claim:

1. A soft fishing supply organizer and storage case comprising:
a bottom portion having a divider within said bottom portion;
a lid having four sides and attached on at least one side to said bottom portion and removably attached on said other sides to said bottom portion; and
identification cards, wherein said cards can be placed within said bottom portion for categorizing soft plastic bait bags.

2. The fishing case of claim 1 wherein said cards have identification labels therein for categorizing said soft plastic bait bags.

3. The fishing case of claim 1 wherein said identification cards has a tab which extends above the rest of the card.

4. The fishing case of claim 3 wherein an identification label can placed on said tab, said label is useful for identification and categorization of said soft plastic bait bags.

5. The fishing case of claim 1 wherein said bottom portion comprises two parts, a lower part being made of a waterproof plastic and an upper part being made of a durable nylon.

6. The fishing case of claim 1 wherein said durable nylon of said upper part is water resistant.

7. The fishing case of claim 1 wherein said divider is permanently affixed to said bottom portion.

8. The fishing case of claim 6 wherein said divider is located down the middle of the bottom portion of said case.

9. The fishing case of claim 1 wherein said case can hold at least 60 soft plastic bait bags.

10. The fishing case of claim 1 wherein said lid has a pocket therein.

11. The fishing case of claim 10 wherein said pocket is a mesh pocket.

12. A fishing supply organizer and storage case wherein said fishing case is divided for categorizing fishing bait and supplies, said case comprising:
a bottom portion and a lid; and
a filing system comprising identification cards,
wherein said cards are placed within said divided case for categorizing bait and fishing supplies.

13. The fishing case of claim 12 wherein said case is made of a molded plastic.

14. The fishing case of claim 12 wherein said case is made of a soft material.

15. The fishing case of claim 14 wherein said bottom portion comprises two parts, a lower part being made of a waterproof plastic and an upper part being made of a durable nylon.

16. The fishing case of claim 12 wherein said cards have identification labels therein for categorizing fishing supplies.

17. The fishing case of claim 12 wherein said lid has a pocket therein.

18. The fishing case of claim 17 wherein said pocket is a mesh pocket.
